(19) United States
(12) Patent Application Publication
(10) Pub. No.: US 2026/0146936 A1
(43) Pub. Date: May 28, 2026

(54) ADJUSTABLE MULTI-LIGHT-SOURCE EXPERIMENTAL DEVICE AND METHOD FOR MEASURING LIGHT SCATTERING PROPERTIES OF PARTICULATE MATTER

(71) Applicant: SHANDONG UNIVERSITY OF SCIENCE AND TECHNOLOGY, QINGDAO (CN)

(72) Inventors: WEN NIE, QINGDAO (CN); CHENYANG ZHOU, QINGDAO (CN); HUITIAN PENG, QINGDAO (CN); CHANGWEI XU, QINGDAO (CN); JUNCHAO WAN, QINGDAO (CN); HUAITONG LI, QINGDAO (CN); YUXIN DOU, QINGDAO (CN); YUPING LI, QINGDAO (CN); FEI LIU, QINGDAO (CN)

(21) Appl. No.: 19/402,013

(22) Filed: Nov. 26, 2025

(30) Foreign Application Priority Data
Nov. 28, 2024 (CN) 202411723185.9

(51) Int. Cl. G01N 15/075; G01N 1/24

(52) U.S. Cl. CPC G01N 15/075; G01N 1/24

(57) ABSTRACT

measuring scattering properties of a particulate matter. The experimental device includes a detachably arranged laser device, an incident light passage, a scattered light passage, a photodetector and a spherical scattering cavity, wherein the laser device, the incident light passage and the scattered light passage can rotate 360 degrees around the spherical scattering cavity for any angle adjustment. The invention can perform multi-light-source and multi-angle laser incidence and multi-angle detector detection so as to obtain scattering information of particulate matters in various samples to be measured.

### BACKGROUND OF THE INVENTION

### 1. Technical Field

The present invention relates to the technical field of light scattering property detection for particulate matters and, in particular, to an adjustable multi-light-source experimental device and method for measuring the light scattering properties of particulate matters.

### 2. Description of Related Art

With the development of society, dust concentration monitoring instruments have developed rapidly. Their main methods include light scattering method, gravity sedimentation method, β-ray method, weighing method and electrostatic induction method. Among them, the more widely used method is the light scattering method, which irradiates dust particles with laser light to generate scattered light, and measure the intensity of the scattered light to calculate dust concentration. In modern environmental monitoring and particle physics research, the light scattering properties of particulate matters are a key research area. Light scattering properties provide important information about particle size, shape, composition and optical properties, and are of great significance for understanding particulate matters in the atmosphere and water, as well as cells and microparticles in the biomedical field. Known light scattering experimental systems usually only use one type of light source to irradiate particles for scattering experiments, or are not adjustable, with relatively fixed optical configurations, for the angles between light sources, between light sources and detectors, and between detectors, as well as the distances between optical components. In the process of measuring particles of different particle sizes or different material compositions, these limitations may cause difficulties such as inaccurate or incomplete measurements.

### BRIEF SUMMARY OF THE INVENTION

Aiming at the aforementioned defects existing in the prior art, the technical problem to be solved by the present invention is to provide an adjustable multi-light-source experimental device and method for measuring scattering properties of a particulate matter, which can perform multi-light-source and multi-angle laser incidence and multi-angle detector detection on particles of different particle sizes or different material compositions.

In order to solve the above technical problems, the present invention adopts the following technical solutions: An adjustable multi-light-source experimental device for measuring scattering properties of a particulate matter includes: a detachably arranged laser device, an incident light passage, a scattered light passage, a photodetector, a spherical scattering cavity, an optical power meter, an oscilloscope, a steam generator, a dust generator and optical cameras. At least one incident light passage is provided, and the number of laser devices is provided corresponding to that of incident light passages. The incident light passage and the scattered light passage are respectively arranged on corresponding support foot assemblies by means of optical brackets, and the support foot assemblies are slidably mounted on a circular slide rail, so that the laser device, the incident light passage and the scattered light passage can rotate 360 degrees around the spherical scattering cavity for any angle adjustment. A probe of the optical power meter or the photodetector is mounted at an output end of the scattered light passage in a replaceable manner. The photodetector is configured to convert a light power signal into a voltage signal and output the converted voltage signal by means of the oscilloscope. The dust generator is configured to provide dust to scatter with an incident laser beam. The steam generator is configured to create different humidity environments. The optical cameras are aligned with the incident light passage and the scattered light passage respectively for photographing.

Preferably, the incident light passage is sequentially provided with a fiber interface, a collimating lens and a focusing lens along a laser path, a laser beam emitted by the laser device enters the incident light passage through the fiber interface and is converted into scattered light in the spherical scattering cavity and enters the scattered light passage; the scatter light passage is sequentially provided with a filter, a collimating lens, a focusing lens and an optical fiber interface along a scattered light passage; the scattered light enters a photosensitive area of the probe of the optical power meter through the optical fiber interface; the filter is configured to avoid interference of stray light on the scattering properties; the optical fiber interfaces respectively connect the laser and the incident light passage, as well as the scattered light and the detector respectively, so as to solve the difficulty of arrangement of light sources and passages on a same horizontal line.

Preferably, the spherical scattering cavity is provided with a horizontal cut along the middle such that the spherical scattering cavity is divided into two hemispheres, and a circular track is mounted inside an edge of the cut, and the two hemispheres are supported and connected by at least one double-ended sliding bracket, with a 3 mm scattering cavity gap being reserved on a middle surface of the spherical scattering cavity; the positions of all support points are adjustable according to changes in light paths to avoid interfering with the light paths; the support points can be moved to an angle area that is temporarily not used in an experiment to realize the measurement of particulate matter scattering at all scattering angles.

Preferably, steam and dust particles generated by the steam generator and the dust generator enter the spherical scattering cavity by means of a pneumatic pump to scatter with the incident laser beam, and the auxiliary air extraction by an air compressor realizes the stability of dust circulation.

Preferably, the spherical scattering cavity is provided with an internal dust passage and uses dry N2 as a protective gas to prevent dust diffusion from contaminating a detection cavity.

Preferably, the slide rail is fixedly mounted on a honeycomb breadboard which can effectively resist the impact of external vibration and shock to ensure stable operation of the experimental device.

Preferably, the experimental device for measuring scattering properties of a particulate matter further includes a light shield which can reduce the impact of external light on the experiment; the oscilloscope is provided with six channels which can be connected to six photodetectors simultaneously to detect voltage signals converted at six scattering angles.

Preferably, the incident light passages and the scattered light passage are both coated with organic dyes; directly facing each incident light passage, a light trap is disposed 5 cm behind the spherical scattering cavity; the bottom of each light trap is mounted by means of a double-headed screw and is in the same line as the incident laser beam; the light traps are configured to absorb scattered incident light.

An adjustable multi-light-source experimental method for measuring the light scattering properties of a particulate matter is provided, using an adjustable multi-light-source experimental method for measuring the light scattering properties of a particulate matter, and the specific steps are as follows:

in step 1, the laser device is started to emit an incident laser beam, and the incident laser beam is introduced into the laser passage through the optical fiber interface; the laser beam passes through the collimating lens and is turned into a collimated beam; and the collimated beam is focused by the focusing lens to improve the utilization rate of the beam and then is injected into the spherical scattering cavity□

in step 2, a humidity environment is created by means of the steam generator, and dust particles are provided by the dust generator, and the dust particles and steam with a required humidity are introduced into the spherical scattering cavity to scatter with the incident laser beam, and the incident laser beam becomes scattered light□

in step 3, the scattered light exits the spherical scattering cavity and then enters the scattered light passage; the scattered light is first filtered by the filter for removal of stray light, and then passes through the collimating lens and is turned into a collimated light beam, and finally the collimated light beam is focused by the focusing lens and injected into the photosensitive area of the optical power meter to obtain scattered light power signals of the particulate matter in a sample to be measured at a plurality of scattering angles;

in step 4, the optical power meter is replaced with a photodetector to convert the light power signals into voltage signals and the converted voltage signals are output using the oscilloscope;

in step 5, the optical brackets are adjusted to drive the incident light passage and the scattered light passage to rotate around the spherical scattering cavity, so as to measure the properties of scattered light from different angles, and the steam generator is used to create different humidity environments to study the light scattering properties of the particulate matter in different humidity environments; and

in step 6, according to the comparison of the scattered light power signal, the voltage signal and dust mass concentration, a linear relationship between the dust mass concentration and the voltage signal is obtained; an optical camera is directly used to capture the scattering properties of the particulate matter, and captured images are output by supporting software, and the scattering properties of different particulate matters are analyzed.

Preferably, in step 1, the continuous and dynamic adjustment of laser wavelength is achieved by splitting light with a software-controlled grating spectrometer, or by directly replacing laser devices with different wavelengths and powers on the optical brackets; light sources with multiple different wavelengths are selected to cover the spectrum ranging from ultraviolet (UV) to infrared (IR).

Beneficial effects of the invention: (1) By slidably mounting the incident light passage and the scattered light passage on a circular slide track, the angle between light sources can be adjusted by rotating around the spherical scattering cavity for a full circle. This facilitates the measurement of scattered light properties at different angles and enables 360° dynamic adjustment of an incident laser beam and a received scattering angle.
(2) The number of incident light passages is determined according to the requirements of an experiment; therefore, the scattering characteristics of particulate matters under multi-laser and multi-angle irradiation can be explored, or the property detection of particulate matters under single-laser irradiation can be realized.
(3) The steam generator is used to adjust different humidity environments to simulate various humidity application scenarios. Meanwhile, the dust generator is adopted to experimentally study the scattering properties of particulate matters with different particle sizes and compositions under different humidity conditions.
(4) By utilizing devices such as optical power meters, photodetectors, oscilloscopes, and optical cameras, the device and method of the present invention can comprehensively collect and analyze the power signals and voltage signals of scattered light, as well as the real-time scattering of particulate matters, providing multi-dimensional and multi-angle information on scattering properties of particulate matters.
(5) All components included in the experimental device are detachable and replaceable, improving applicability and convenience. The multi-light-source and multi-angle configuration can ensure more detailed and comprehensive measurement of light scattering properties of different particulate matters.

### BRIEF DESCRIPTION OF THE SEVERAL VIEWS OF THE DRAWINGS

FIG. 1 shows an assembly of the experimental system for measuring light scattering properties of a particulate matter;

FIG. 2 shows a front view of a particulate matter scattering detection structure;

FIG. 3 shows a side view of the particulate matter scattering detection structure;

FIG. 4 shows a top view of the particulate matter scattering detection structure;

FIG. 5 shows a schematic diagram of a spherical scattering cavity; and

FIG. 6 shows a flowchart of a basic experimental device of the present invention.

Reference numerals: 1. honeycomb breadboard; 2. slide rail; 3. support foot assembly a; 4. laser device a; 5. collimating lens a; 6 optical fiber interface a; 7. focusing lens a; 8. focusing lens b; 9. collimating lens b; 10: optical fiber interface b; 11. laser device b; 12. support foot assembly b; 13. Filter; 14. collimating lens c; 15. focusing lens c; 16. photodetector; 17. support foot assembly c; 18. spherical scattering cavity; 18a. circular track; 18b. double-headed sliding bracket; 19. scattering cavity air inlet; 20. light trap a; 21. light trap b; 22. optical bracket a; 23. optical bracket b; 24. scattering cavity gap; 25. optical bracket c; 26. optical bracket d; 27. optical power meter; 28. oscilloscope; 29. air compressor; 30. pneumatic pump; 31. steam generator; 32. Dust generator; 33. light shield.

### DETAILED DESCRIPTION OF THE INVENTION

In order to better understand the improvements made by the present invention compared with the prior art, the technical solutions in embodiments of the present invention will be clearly and completely described in conjunction with the accompanying drawings. Obviously, the described embodiments are only some, not all of the embodiments of the present invention.

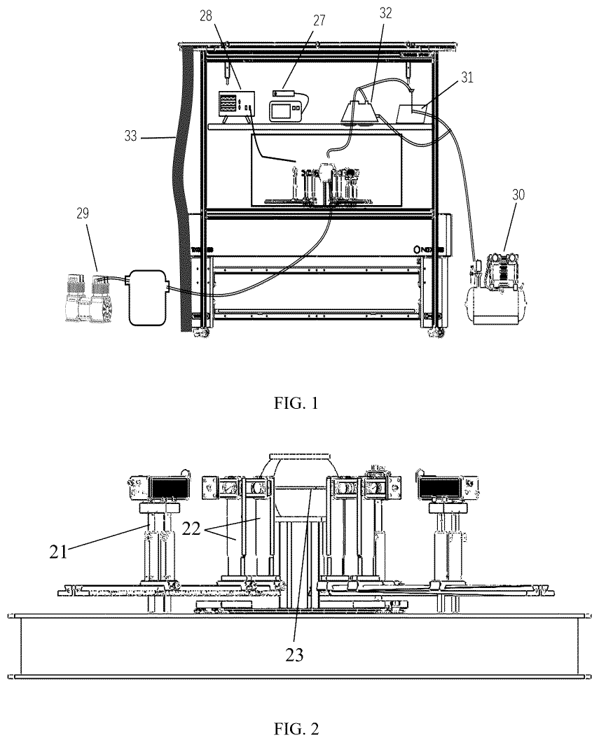

As shown in FIG. 1, an adjustable multi-light-source experimental device for measuring the light scattering properties of a particulate matter mainly comprises detachably arranged laser devices, an incident light passage, a scattered light passage, a photodetector 16, a spherical scattering cavity 18, an optical power meter 27, an oscilloscope 28, a steam generator 31, a dust generator 32 and optical cameras. In order to reduce the impact of external light on the experiment, the experimental device is also provided with a light shield 33. At least one incident light passage is provided, and the number of laser devices is provided corresponding to that of incident light passages.

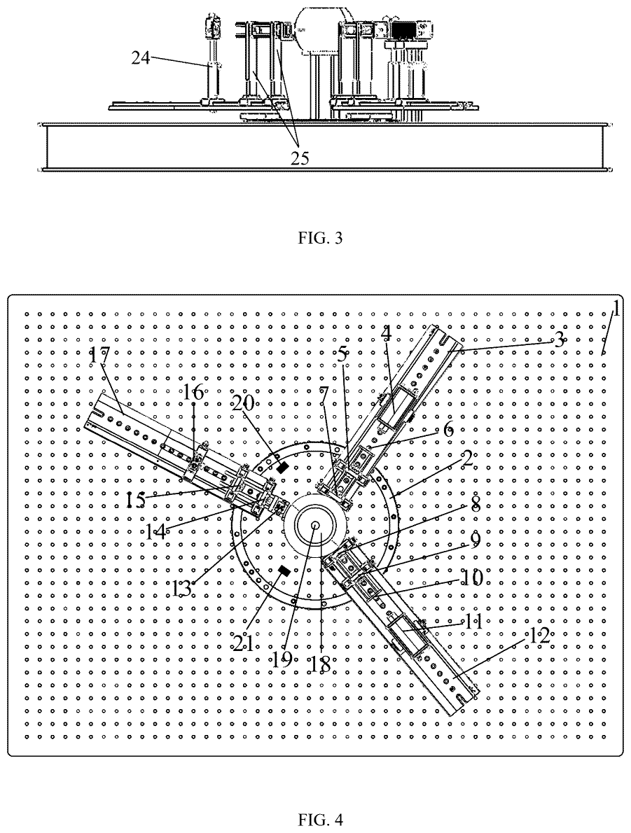

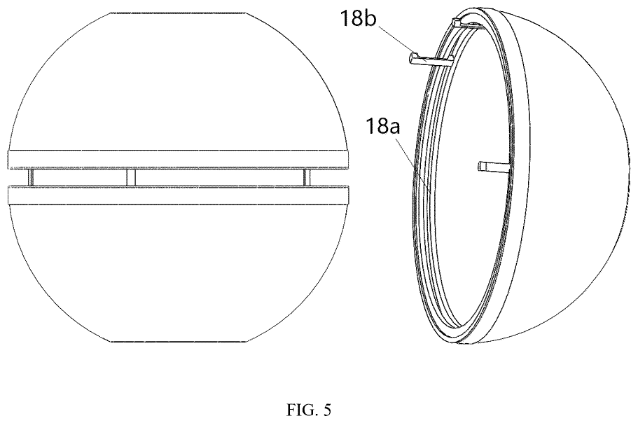

As shown in FIGS. 2-4, the incident light passage and the scattered light passage are respectively arranged on corresponding support foot assemblies by means of optical brackets, and the support foot assemblies are slidably mounted on a circular slide rail 2, so that the laser device, the incident light passage and the scattered light passage can rotate 360 degrees around the spherical scattering cavity 18 for any angle adjustment, which facilitates measuring scattered light properties at different angles. The slide rail 2 is fixedly mounted on a honeycomb breadboard 1. Use of the honeycomb breadboard 1 as an optical experimental platform can effectively resist the impact of external vibration and shock, thereby ensuring stable operation of the experimental device.

As shown in FIG. 5, the spherical scattering cavity 18 is provided with a horizontal cut along the middle such that the spherical scattering cavity 18 is divided into two hemispheres, and a circular track 18a is mounted inside an edge of the cut, and the two hemispheres are supported and connected by at least one double-ended sliding bracket 18b, with a 3 mm scattering cavity gap 24 being reserved on a middle surface of the spherical scattering cavity 18. The scattering cavity gap is used for collecting incident laser beam, incident dust and dust-scattered light. Moreover, the positions of all support points are adjustable according to changes in light paths to avoid interfering with the light paths. The support points may be moved to an angle area that is temporarily not used in an experiment to realize the measurement of the particulate matter scattering at all scattering angles. The spherical scattering cavity 18 is mainly composed of four parts: a scattering cavity air inlet 19, a protective gas structure, a spherical cavity and a scattering cavity air outlet. The scattering cavity air inlet 19 and the scattering cavity air outlet are cylindrical passages with a diameter of 1.5 cm. The spherical scattering cavity 18 is provided with an internal dust passage and uses dry N2 as a protective gas.

When two incident light passages are provided, the scattering properties of the particulate matter under multi-laser and multi-angle irradiation are explored. A first incident light passage is sequentially provided with a fiber interface a 6, a collimating lens a 5 and a focusing lens a 7 along a laser path. A laser beam is emitted by a laser device a 4 and enters the first incident light passage through the fiber interface a 6. A second incident light passage is sequentially provided with a fiber interface b 10, a collimating lens b 9 and a focusing lens b 8 along a laser path of which the laser light is emitted by a laser device b 11 and enters the second incident light passage through the fiber interface b 10. The laser light in the two incident light passages is converted into scattered light in the spherical scattering cavity 18 and enters the scattered light passage. Moreover, when one incident light passage is provided, the property detection of the particulate matter irradiated by a single laser can be realized.

At least one scattered light passage is provided, and a filter 13, a collimating lens c 14, a focusing lens c 15 and an optical fiber interface c are sequentially arranged along the scattered light passage. The scattered light enters a photosensitive area of a probe of the optical power meter 27 through the optical fiber interface c. The filter 13 is configured to avoid interference of stray light on the scattering properties. The probe of the optical power meter 27 or the photodetector 16 is mounted at an output end of the scattered light passage in a replaceable manner. The photodetector 16 is configured to convert a light power signal into a voltage signal and output the converted voltage signal by means of the oscilloscope 28. The oscilloscope 28 is provided with six channels, so that six photodetectors can be connected simultaneously to detect voltage signals converted at six scattering angles.

The optical fiber interface group connects the laser light and incident light passages, as well as the scattered light and the detectors respectively, so as to solve the difficulty of arrangement of light sources and passages on the same horizontal line. Moreover, the incident light passages and the scattered light passage are both coated with organic dyes. The two incident light passages and one scattered light passage are respectively mounted on a corresponding optical bracket a 22, optical bracket b 23, and optical bracket d 26, and the optical camera is mounted on an optical bracket c 25. Directly facing each incident light passage, a light trap is disposed 5 cm behind the spherical scattering cavity 18. The bottom of each light trap is mounted by means of a double-headed screw and is in the same line as the incident laser beam. The light traps are configured to absorb the scattered incident light. The first incident light passage corresponds to a light trap b 21, and the second incident light passage corresponds to a light trap a 20.

The dust generator 32 is configured to provide dust to scatter with the incident laser beam. The steam generator 31 is configured to create different humidity environments. Steam and dust particles generated by the steam generator 31 and the dust generator 32 enter the spherical scattering cavity 18 by means of an air compressor 29 and a pneumatic pump 30 to scatter with the incident laser beam, and the auxiliary air extraction by the air compressor 29 realizes the stability of dust circulation. The experimental device is further provided with optical cameras that are aligned with the incident light passages and the scattered light passage respectively for photographing. The optical cameras directly capture the scattering of particulate matters and respectively obtains the scattering information of particulate matters in various samples to be measured at different scattering angles or different humidities.

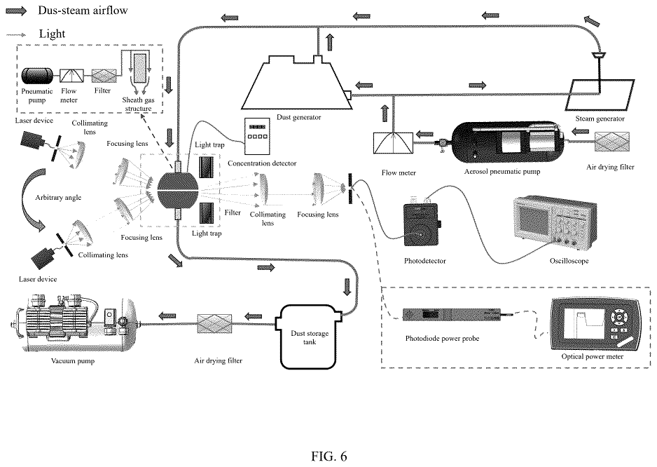

As shown in FIG. 6, an adjustable multi-light-source experimental method for measuring the light scattering properties of a particulate matter is provided, using the above-described experimental device, and the specific steps are as follows:

In step 1, the laser devices are started to emit incident laser beams, and the corresponding incident laser beams are introduced into the laser passages through respective optical fiber interfaces; the laser beams pass through collimating lenses and are turned into collimated beams; and the beams are focused by focusing lenses to improve the utilization rate of the collimated beams and are injected into the spherical scattering cavity 18. The continuous and dynamic adjustment of laser wavelength can be achieved by splitting light with a software-controlled grating spectrometer, or by directly replacing laser devices with different wavelengths and powers on the optical brackets. Additionally, filters, collimating lenses, and focusing lenses with different parameters can be removed and replaced as needed.

In step 2, a humidity environment is created by means of the steam generator 31 to study the light scattering properties of the particulate matter in different humidity environments, and dust particles are provided by the dust generator 32, and the dust particles and steam with a required humidity are introduced into the spherical scattering cavity 18 to scatter with the incident laser beams, and the incident laser beams become scattered light.

In step 3, the scattered light exits the spherical scattering cavity 18 and then enters the scattered light passage. The scattered light is first filtered by a filter for removal of stray light, and then passes through the collimating lens and is turned into a collimated light beam, and finally the collimated light beam is focused by the focusing lens and injected into the photosensitive area of the optical power meter 27 to obtain scattered light power signals of the particulate matter in a sample to be measured at a plurality of scattering angles.

In step 4, the optical power meter 27 is replaced with a photodetector to convert the light power signals into voltage signals and the converted voltage signals are output using the oscilloscope 28. In this step, a Tektronix oscilloscope and Thorlabs optical power meter which have higher sensitivity are used for better capture of scattered signals.

In step 5, the optical brackets are adjusted to drive the incident light passages and the scattered light passage to rotate around the spherical scattering cavity 18, so that included angles between the laser devices, included angles between the detectors, and included angles between the laser devices and the detectors are adjusted to measure the properties of scattered light from different angles, and the steam generator 31 is used to create different humidity environments to study the light scattering properties of the particulate matter in different humidity environments; and collimating and focusing lenses with different parameters can be detachably mounted on a main body of each laser passage.

In step 6, according to the comparison of the scattered light power signal, the voltage signal and the dust mass concentration, a linear relationship between the dust mass concentration and the voltage signal is obtained. The scattered light power signals of the particulate matter in the sample to be measured at a plurality of scattering angles and different humidities are converted by the photodetectors into voltage signals; the photodetectors are connected to the oscilloscope, and the oscilloscope outputs the converted voltage signals, the voltage signals and the scattered light power signals are compared, and a functional relationship between scattered light power and output voltage is established. The optical cameras directly capture the scattering of particulate matters and respectively obtains the scattering information of particulate matters in various samples to be measured at different scattering angles or different humidities. The captured images are output by supporting software, and the scattering properties of different particulate matters are analyzed.

The above are only preferred embodiments of the present invention, but the scope of the present invention is not limited thereto. Any person skilled in the technical field can make equivalent substitutions or changes based on the technical solutions and inventive concepts of the present invention within the technical scope disclosed herein, and all these equivalent substitutions or changes should be covered within the scope of the present invention.

What is claimed is:

1. An adjustable multi-light-source experimental device for measuring scattering properties of a particulate matter, comprising: a detachably arranged laser device, an incident light passage, a scattered light passage, a photodetector (16), a spherical scattering cavity (18), an optical power meter (27), an oscilloscope (28), a steam generator (31), a dust generator (32) and optical cameras, wherein at least one incident light passage is provided, and the number of laser devices is provided corresponding to that of incident light passages; the incident light passage and the scattered light passage are respectively arranged on corresponding support foot assemblies by means of optical brackets, and the support foot assemblies are slidably mounted on a circular slide rail (2), so that the laser device, the incident light passage and the scattered light passage can rotate 360 degrees around the spherical scattering cavity (18) for any angle adjustment; a probe of the optical power meter (27) or the photodetector (16) is mounted at an output end of the scattered light passage in a replaceable manner; the photodetector (16) is configured to convert a light power signal into a voltage signal and output the converted voltage signal by means of the oscilloscope (28); the dust generator (32) is configured to provide dust to scatter with an incident laser beam; the steam generator (31) is configured to create different humidity environments; the optical cameras are aligned with the incident light passage and the scattered light passage respectively for photographing; the spherical scattering cavity (18) is provided with a horizontal cut along the middle such that the spherical scattering cavity (18) is divided into two hemispheres, and a circular track (18a) is mounted inside an edge of the cut, and the two hemispheres are supported and connected by at least one double-ended sliding bracket (18b), with a 3 mm gap being reserved on a middle surface of the spherical scattering cavity (18); the positions of all support points are adjustable according to changes in light paths to avoid interfering with the light paths; steam and dust particles generated by the steam generator (31) and the dust generator (32) enter the spherical scattering cavity (18) by means of a pneumatic pump (30) to scatter with the incident laser beam, and auxiliary air extraction by an air compressor (29) realizes the stability of dust circulation; the experimental device for measuring scattering properties of a particulate matter further comprises a light shield (33) which can reduce the impact of external light on an experiment; the oscilloscope (28) is provided with six channels which are connected to six photodetectors simultaneously to detect voltage signals converted at six scattering angles.

2. The adjustable multi-light-source experimental device for measuring scattering properties of a particulate matter according to claim 1, wherein the incident light passage is sequentially provided with a fiber interface, a collimating lens and a focusing lens along a laser path, a laser beam emitted by the laser device enters the incident light passage through the fiber interface and is converted into scattered light in the spherical scattering cavity (18) and enters the scattered light passage; the scatter light passage is sequentially provided with a filter, a collimating lens, a focusing lens and an optical fiber interface along the scattered light passage; the scattered light enters a photosensitive area of the probe of the optical power meter (27) through the optical fiber interface.

3. The adjustable multi-light-source experimental device for measuring scattering properties of a particulate matter according to claim 1, wherein the spherical scattering cavity (18) is provided with an internal dust passage and uses dry N₂ as a protective gas.

4. The adjustable multi-light-source experimental device for measuring scattering properties of a particulate matter according to claim 1, wherein the slide rail (2) is fixedly mounted on a honeycomb breadboard (1).

5. The adjustable multi-light-source experimental device for measuring scattering properties of a particulate matter according to claim 1, wherein the incident light passages and the scattered light passage are both coated with organic dyes; directly facing each incident light passage, a light trap is disposed 5 cm behind the spherical scattering cavity (18); the bottom of each light trap is mounted by means of a double-headed screw and is in the same line as the incident laser beam; the light traps are configured to absorb scattered incident light.

6. An adjustable multi-light-source experimental method for measuring the light scattering properties of a particulate matter, using the adjustable multi-light-source experimental device for measuring the light scattering properties of a particulate matter according to claim 1, wherein the steps are as follows:
in step 1, the laser device is started to emit an incident laser beam, and the incident laser beam is introduced into the laser passage through the optical fiber interface; the laser beam passes through the collimating lens and is turned into a collimated beam; and the collimated beam is focused by the focusing lens to improve the utilization rate of the beam and then is injected into the spherical scattering cavity (18);
in step 2, a humidity environment is created by means of the steam generator (31), and dust particles are provided by the dust generator (32), and the dust particles and steam with a required humidity are introduced into the spherical scattering cavity (18) to scatter with the incident laser beam, and the incident laser beam becomes scattered light;
in step 3, the scattered light exits the spherical scattering cavity (18) and then enters the scattered light passage; the scattered light is first filtered by the filter for removal of stray light, and then passes through the collimating lens and is turned into a collimated light beam, and finally the collimated light beam is focused by the focusing lens and injected into the photosensitive area of the optical power meter (27) to obtain scattered light power signals of the particulate matter in a sample to be measured at a plurality of scattering angles;
in step 4, the optical power meter (27) is replaced with a photodetector to convert the light power signals into voltage signals and the converted voltage signals are output using the oscilloscope (28);
in step 5, the optical brackets are adjusted to drive the incident light passage and the scattered light passage to rotate around the spherical scattering cavity (18), so as to measure the properties of scattered light from different angles, and the steam generator (31) is used to create different humidity environments to study the light scattering properties of the particulate matter in different humidity environments; and
in step 6, according to the comparison of the scattered light power signals, the voltage signals and dust mass concentration, a linear relationship between the dust mass concentration and the voltage signals is obtained; an optical camera is directly used to capture the scattering properties of the particulate matter, and captured images are output by supporting software and the scattering properties of different particulate matters are analyzed.

7. The adjustable multi-light-source experimental method for measuring scattering properties of a particulate matter according to claim 6, wherein in step 1, the continuous and dynamic adjustment of laser wavelength is achieved by splitting light with a software-controlled grating spectrometer, or by directly replacing laser devices with different wavelengths and powers on the optical brackets.
